(19) United States
(12) Patent Application Publication
(10) Pub. No.: US 2017/0244858 A1
(43) Pub. Date: Aug. 24, 2017

(54) IMAGE FORMING APPARATUS, SERVER APPARATUS, AND RECORDING MEDIUM

(71) Applicant: FUJI XEROX CO., LTD., Tokyo (JP)

(72) Inventors: Tsutomu UDAKA, Yokohama-shi (JP); Atsushi KITAGAWARA, Yokohama-shi (JP); Fumihiko OGASAWARA, Yokohama-shi (JP); Tomoyuki MITSUHASHI, Yokohama-shi (JP)

(73) Assignee: FUJI XEROX CO., LTD., Tokyo (JP)

(21) Appl. No.: 15/239,887

(22) Filed: Aug. 18, 2016

(30) Foreign Application Priority Data
Feb. 24, 2016 (JP) 2016-032667

(51) Int. Cl. H04N 1/00; H04N 1/60; G03G 15/00; H04N 1/29

(52) U.S. Cl. CPC H04N 1/00994; H04N 1/29; H04N 1/6008; H04N 1/00344; G03G 15/50; H04N 2201/0094

(57) ABSTRACT

An image forming apparatus includes plural components that are used to perform an image forming operation, and a drive controller that controls a potential noise source component or a component group containing plural potential noise source components among the plural components to be sequentially driven in an operation state for specifying a noise occurrence place such that a component or a component group having a higher possibility to be a noise source is driven with higher priority or a component or a component group having a lower possibility to be the noise source with lower priority.

### CROSS-REFERENCE TO RELATED APPLICATIONS

This application is based on and claims priority under 35 USC 119 from Japanese Patent Application No. 2016-032667 filed on Feb. 24, 2016.

### BACKGROUND

### Technical Field

The present invention relates to an image forming apparatus, a server apparatus, and a recording medium.

### SUMMARY

According to an aspect of the invention, there is provided an image forming apparatus including: plural components that are used to perform an image forming operation; and a drive controller that controls a potential noise source component or a component group containing plural potential noise source components among the plural components to be sequentially driven in an operation state for specifying a noise occurrence place such that a component or a component group having a higher possibility to be a noise source is driven with higher priority or a component or a component group having a lower possibility to be the noise source with lower priority.

### BRIEF DESCRIPTION OF DRAWINGS

Exemplary embodiments of the present invention will be described in detail based on the following figures, wherein:

FIG. 1 is a diagram illustrating a configuration of an image forming system of an exemplary embodiment of the invention;

FIG. 2 is a block diagram illustrating an exemplary structure of an image forming apparatus 10 in an exemplary embodiment of the invention;

FIG. 3 is a block diagram illustrating a hardware configuration of a controller in the image forming apparatus of an exemplary embodiment of the invention;

FIG. 4 is a block diagram illustrating a functional configuration of the controller 20 in the image forming apparatus of an exemplary embodiment of the invention;

FIG. 5 is a diagram for describing an exemplary sequence of components driven in an all-component continuous drive mode;

FIG. 6 is a diagram for describing exemplary sequences of the components driven in a division drive mode;

FIG. 7 is a diagram illustrating an exemplary screen displayed in an operation panel of the image forming apparatus when a noise confirming operation is performed;

FIGS. 8A and 8B are diagrams for describing an operation in a case where a noise occurrence checking frame is operated during driving of a component;

FIG. 9 is a diagram illustrating an exemplary screen in a case where a tablet terminal device displays information of components during driving;

FIG. 10 is a diagram illustrating an example in a case where a drive order of the respective components is changed by an instruction from a management server apparatus;

FIGS. 11A and 11B are diagrams for describing a situation in a case where the drive order of the components is changed according to whether an installing area of the image forming apparatus is a high humidity/temperature area;

FIG. 12 is a diagram illustrating an example in a case where the drive order is changed based on the cumulative number of printed sheets;

FIG. 13 is a diagram illustrating an exemplary drive in a case where some of plural components are simultaneously driven as a component group compared to the exemplary drive for each component in the all-component continuous drive mode as illustrated in FIG. 5; and

FIG. 14 is a diagram illustrating an exemplary drive in a case where some (potential noise source components) of the plural components are simultaneously driven as a component group in the division drive mode when the components are independently driven as illustrated in FIG. 6.

### DETAILED DESCRIPTION

Hereinafter, exemplary embodiments of the invention will be described in detail with reference to the drawings.

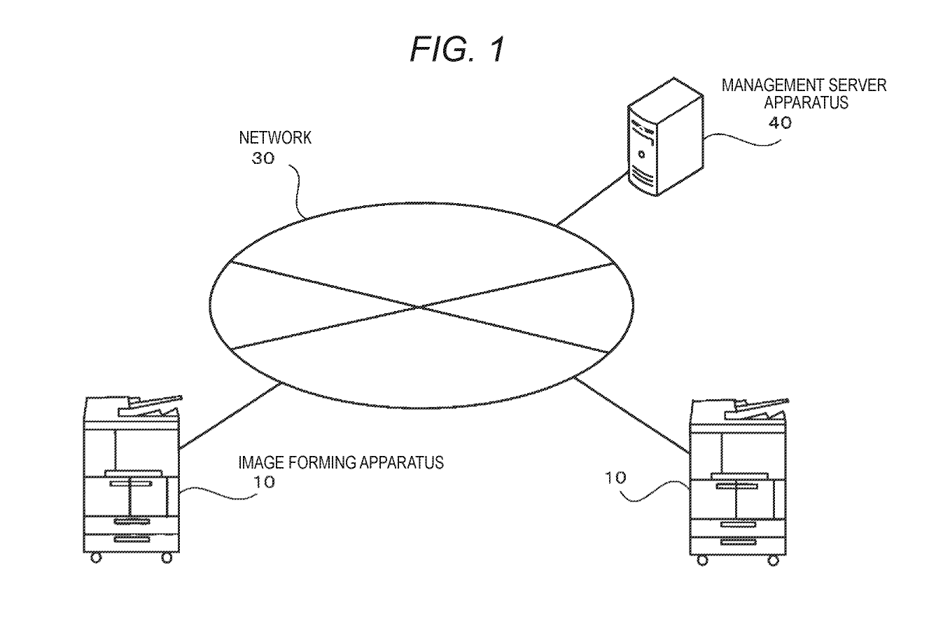

FIG. 1 is a diagram illustrating a configuration of an image forming system of an exemplary embodiment of the invention.

The image forming system of this exemplary embodiment is configured with plural image forming apparatuses 10 connected through a network 30 and a management server apparatus 40 as illustrated in FIG. 1. The image forming apparatus 10 receives print data as an input, and outputs an image according to the print data onto a sheet. The image forming apparatus 10 is called a multifunction machine which has plural functions such as a print function, a scan function, a copy function, and a facsimile function.

In addition, the management server apparatus 40 receives information of a component which causes the noise from the image forming apparatus 10. The management server apparatus 40 generates and manages a list of component having a high noise occurrence frequency based on the received information of the component which causes the noise. A detailed operation of the management server apparatus 40 will be described below.

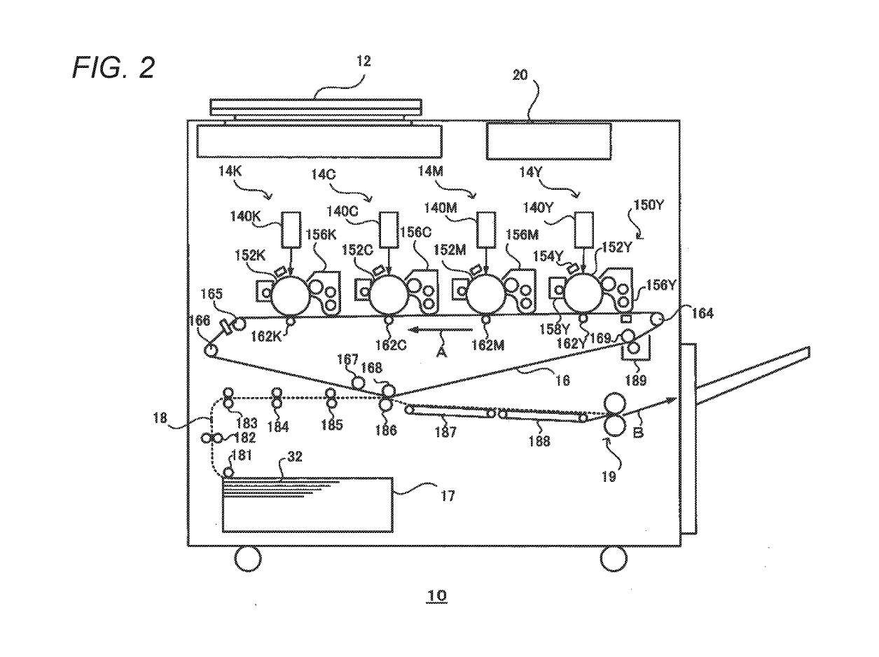

Next, the configuration of the image forming apparatus 10 in FIG. 1 will be described with reference to FIG. 2. FIG. 2 is a schematic diagram for describing an exemplary structure of the image forming apparatus 10 of which the outer appearance is differently illustrated from that of the image forming apparatus 10 in FIG. 1.

As illustrated in FIG. 2, the image forming apparatus 10 includes an image reader 12, image forming units 14K, 14C, 14M, and 14Y, an intermediate transfer belt 16, a sheet tray 17, a sheet transport path 18, a fixing machine 19, and a controller 20. The image forming apparatus 10 may be a multifunction machine having a function as a full-color copier using the image reader 12 and a function as a facsimile machine in addition to a printer function of printing image data received from a personal computer (not illustrated).

First, making an explanation on the outline of the image forming apparatus 10, the image reader 12 and the controller 20 are disposed as input units of the image data on the upper portion of the image forming apparatus 10. The image reader 12 reads an image drawn in an original document and outputs the image to the controller 20. The controller 20 performs image processing such as a gradation correction and a resolution correction on the image data input from the image reader 12 or the image data input from a personal computer (not illustrated) through a network line such as a LAN, and outputs the image data to the image forming unit 14.

Four image forming units 14K, 14C, 14M, and 14Y are disposed in the lower portion of the image reader 12 in accordance with colors for a color image. Four image forming units 14K, 14C, 14M, and 14Y corresponding to the respective color of black (K), cyan (C), magenta (M), and yellow (Y) in this exemplary embodiment are horizontally arranged with a constant gap therebetween along the intermediate transfer belt 16. The intermediate transfer belt 16 is rotated as an intermediate transfer body in a direction of arrow A in the drawing. These four image forming units 14K, 14Y, 14M, and 14C sequentially form toner images of the respective colors based on the image data input from the controller 20. The plural toner images are transferred onto the intermediate transfer belt 16 at a timing when the images are overlapped (primary transfer). The order of the colors of the respective image forming units 14K, 14C, 14M, and 14Y is not limited to the order of black (K), cyan (C), magenta (M), and yellow (Y), and the order is arbitrarily set like an order of yellow (Y), magenta (M), cyan (C), and black (K).

The sheet transport path 18 is disposed below the intermediate transfer belt 16. A recording sheet 32 supplied from the sheet tray 17 is transported on the sheet transport path 18. The color toner images transferred onto the intermediate transfer belt 16 in an overlapped manner are collectively transferred (secondary transfer). The transferred toner images are fixed by the fixing machine 19, and the sheet is discharged to the outside along arrow B.

Next, the respective configurations of the image forming apparatus 10 will be described in detail.

The controller 20 performs a predetermined image processing such as a shading correction, a displacement correction of the original document, a lightness/color space conversion, a gamma correction, a frame erasing process, and a color/movement editing process on the image data which is read by the image reader 12. A reflected light image of the colorant of the original document read by the image reader 12 is, for example, reflectivity data of three colors (red (R), green (G), and blue (B) (each 8 bits)) of the original document. Through the image processing of the controller 20, the reflection light image is converted into gradation data of four colors (black (K), cyan (C), magenta (M), and yellow (Y) (each 8 bits)) of the original document.

The image forming units 14K, 14C, 14M, and 14Y (image forming unit) are disposed in parallel with a constant gap therebetween in the horizontal direction. The image forming units have almost the same configuration except the color of the image to be formed. Hereinafter, the image forming unit 14K will be described. The configurations of the respective image forming units 14 are distinguished by attaching a suffix such as K, C, M, or Y.

The image forming unit 14K includes an optical scanning device 140K which emits a laser beam for the scanning according to the image data input from the controller 20, and an image forming device 150K which forms an electrostatic latent image using the laser beam emitted by the optical scanning device 140K.

The optical scanning device 140K modulates the laser beam according to the black (K) image data, and irradiates a photoconductor drum 152K of the image forming device 150K with the laser beam.

The image forming device 150K is configured with the photoconductor drum 152K which rotates at a predetermined speed along the direction of arrow A, a charging device 154K which serves as a charging unit to evenly charge the surface of the photoconductor drum 152K, a developing device 156K which develops the electrostatic latent image formed on the photoconductor drum 152K, and a cleaning device 158K. The photoconductor drum 152K is a cylindrical image holding member which holds a developer image such as the toner image. The photoconductor drum 152K is evenly charged by the charging device 154K, and irradiated with the laser beam by the optical scanning device 140K to form the electrostatic latent image. The electrostatic latent image formed on the photoconductor drum 152K is developed by the developing device 156K using the developer such as the black (K) toner, and transferred onto the intermediate transfer belt 16. The residual toner and paper dust attached to the photoconductor drum 152K after transferring the toner image (developer image) are removed by the cleaning device 158K.

The other image forming units 14C, 14M, and 14Y also include respectively the photoconductor drums 152C, 152M, and 152Y and the developing devices 156C, 156M, and 156Y. The image forming units 14C, 14M, and 14Y form the toner image of the respective colors cyan (C), magenta (M), and yellow (Y), and transfer the formed toner images of the respective colors onto the intermediate transfer belt 16.

The intermediate transfer belt 16 is rotated while applying a predetermined tension between a drive roll 164, idle rolls 165, 166, and 167, and a backup roll 168, and an idle roll 169. The intermediate transfer belt 16 is circularly driven at a predetermined speed in the direction of arrow A when the drive roll 164 is rotatably driven by a driving motor (not illustrated). The intermediate transfer belt 16 is formed in a belt shape made of a flexible compound resin such as polyimide. Both ends of the synthetic resin film formed in the belt shape are welded and fixed so as to form an endless belt shape.

Primary transfer rolls 162K, 162C, 162M, and 162Y are respectively disposed at positions facing the image forming units 14K, 14C, 14M, and 14Y in the intermediate transfer belt 16. The toner images of the respective colors formed on the photoconductor drums 152K, 152C, 152M, and 152Y are transferred onto the intermediate transfer belt 16 in an overlapping manner by these primary transfer rolls 162. The residual toner attached to the intermediate transfer belt 16 is removed by a cleaning blade or a brush of a belt cleaning device 189 provided on the downstream of a secondary transfer position.

A sheet feeding roll 181 which takes out the recording sheet 32 from the sheet tray 17, first to third roll pairs 182, 183, and 184 which transfer the sheet, and a registration roll 185 which transports the recoding sheet 32 to the secondary transfer position at a predetermined timing are disposed in the sheet transport path 18.

In addition, a secondary transfer roll 186 which comes in pressure contact with the backup roll 168 is disposed at the secondary transfer position on the sheet transport path 18. The toner images of the respective colors transferred onto the intermediate transfer belt 16 in an overlapping manner are secondarily transferred onto the recording sheet 32 through the pressure contact force of the secondary recording roll 186 and an electrostatic force. The recording sheet 32 transferred with the toner images of the respective colors is transported to the fixing machine 19 by transport belts 187 and 188.

The fixing machine 19 applies heat and pressure onto the recording sheet 32 transferred with the toner images of the respective color. The toner is melted and fixed to the recording sheet 32.

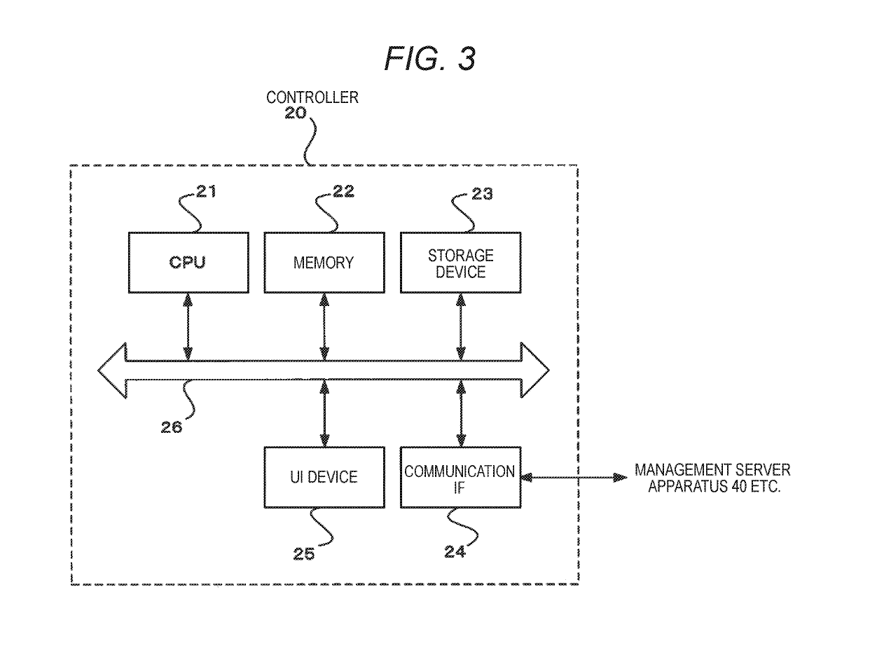

FIG. 3 is a diagram illustrating a hardware configuration of the controller 20 illustrated in FIG. 2.

The controller 20 includes, as illustrated in FIG. 3, a storage device 23 such as a CPU 21, a memory 22, a hard disk drive (HDD), a communication interface (IF) 24 which transmits and receives data with respect to an external device such as the management server apparatus 40 through the network 30, and a user interface (UI) device 25 which includes a touch panel, a liquid crystal display, and a keyboard. These components are connected to each other through a control bus 26.

The CPU 21 performs a predetermined process based on a control program stored in the memory 22 or the storage device 23, and controls the operation of the image forming apparatus 10. While the CPU 21 in this exemplary embodiment is described to read and execute the control program stored in the memory 22 or the storage device 23, the program may be stored in a storage medium such as a CD-ROM and provided to the CPU 21.

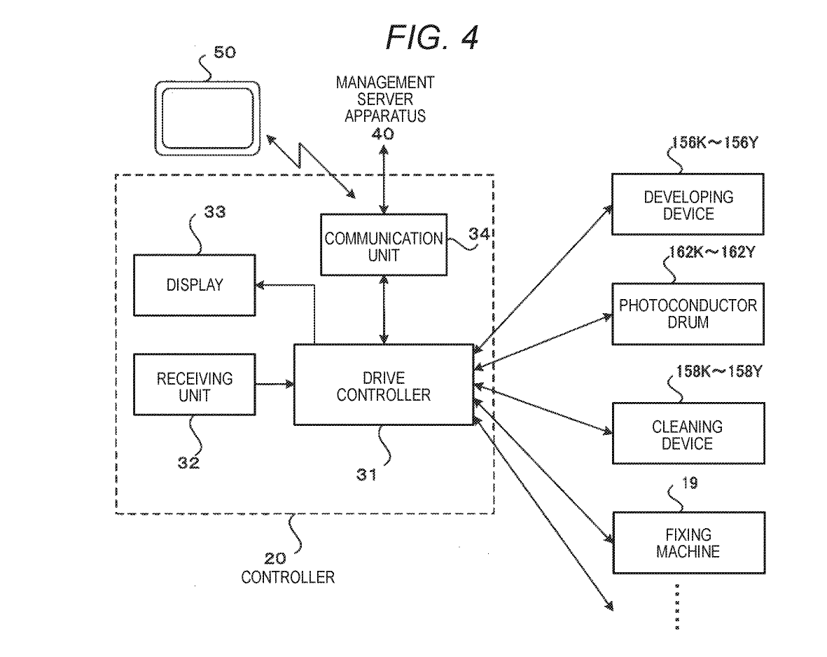

FIG. 4 is a block diagram illustrating a functional configuration of the controller 20 which is realized by executing the control program.

As illustrated in FIG. 4, the controller 20 of this exemplary embodiment is provided with a drive controller 31, a receiving unit 32, a display 33, and a communication unit 34.

The drive controller 31 controls the driving of plural components for realizing image forming operations of the developing devices 156K to 156Y, photoconductor drums 162K to 162Y, the cleaning devices 158K to 158Y, and the fixing machine 19.

The controller 20 includes a diagnosis mode of specifying a defective place or searching a cause thereof, besides a normal operation mode of outputting an image onto the sheet. There is a noise confirming operation mode which is an operation mode (operation state) for specifying a noisy place in a case where a noise is generated in the image forming apparatus 10 in the diagnosis mode.

In the noise confirming operation mode for specifying the noisy place, the drive controller 31 controls the component having a higher possibility to be the noise source to be sequentially driven with higher priority or the component having a lower possibility to be the noise source to be sequentially driven with lower priority among the plural components for realizing the image forming operation.

For example, the drive controller 31 sequentially drives the plural components independently such that a certain component is independently driven for 5 seconds, and the next component is independently driven for 5 seconds with an interval time (stop time) of several seconds therebetween.

The receiving unit 32 receives a drive stop instruction from a user during a time when the respective components for confirming the presence/absence of the noise are driven.

The display 33 displays information such as the name of the component driven by the drive controller 31 and a drive mode.

The display 33 displays operation information necessary for taking noise countermeasures against the component which is being driven when the drive stop instruction received by the receiving unit 32 through an operation panel.

The communication unit 34 transmits and receives the data with respect to the management server apparatus 40 through the network 30. The communication unit 34 communicates with a tablet terminal device 50 or a mobile terminal such as a smart phone. The communication unit 34 transmits and receives the data through a wireless communication using radio frequencies with respect to the mobile terminal. The communication unit 34 may transmit and receive the data with respect to the mobile terminal using an optical signal or an audio signal.

Herein, in the noise confirming operation mode, the drive controller 31 can perform an all-component continuous drive mode or a division drive mode in a selective or switchable manner. In the all-component continuous drive mode, all the potential noise source components among the plural components are sequentially driven in a descending order of the possibility to be the noise source. In the division drive mode, some of the potential noise source components among the plural components are sequentially driven such that the component having a higher possibility to be the noise source is driven with higher priority or the component having a lower possibility to be the noise source is driven with lower priority.

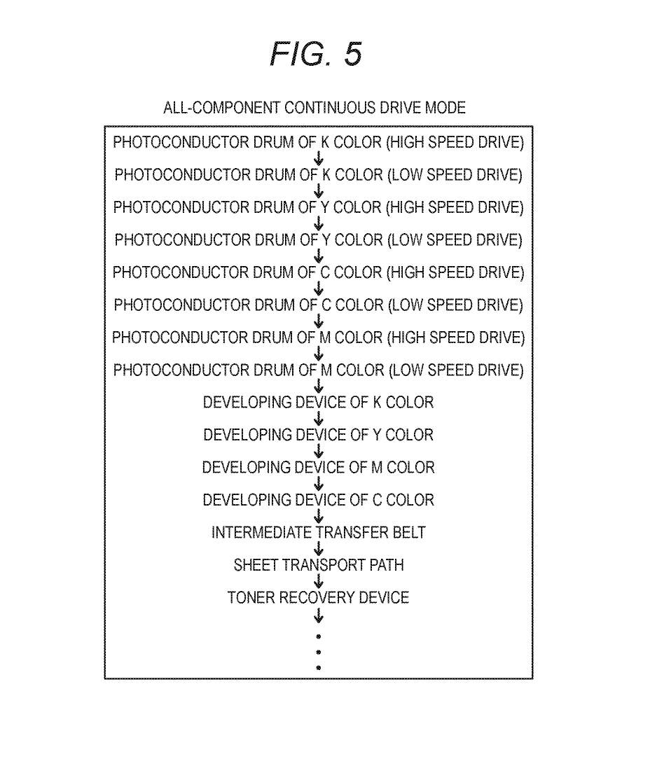

FIG. 5 illustrates an example of a drive sequence of the respective components of the image forming apparatus 10 in the all-component continuous drive mode.

In the all-component continuous drive mode, the order of the potential noise source components to be driven by the drive controller 31 is determined by the noise occurrence frequency based on history information of the past. In other words, a component having a higher noise occurrence frequency in the history information of the past is set to be driven at a higher rank.

In the exemplary sequence illustrated in FIG. 5, the photoconductor drum 152K of K color is first driven at a high speed. Next, the photoconductor drum 152K of K color is driven at a low speed. Thereafter, the photoconductor drum 152Y of Y color is driven at a low speed. In this way, the respective components are sequentially driven.

The drive speed of each component is set to a drive speed at which the noise is most easy to occur structurally. However, an easy-to-occur noise at a high speed drive and an easy-to-occur noise at a low speed drive may be different even in the same component. For such a component, two types of drive speeds such as a high speed drive and a low speed drive are set for the same component.

For example, in the example illustrated in FIG. 5, modes of driving at two types of speeds such as the high speed drive and the low speed drive are set to the photoconductor drum.

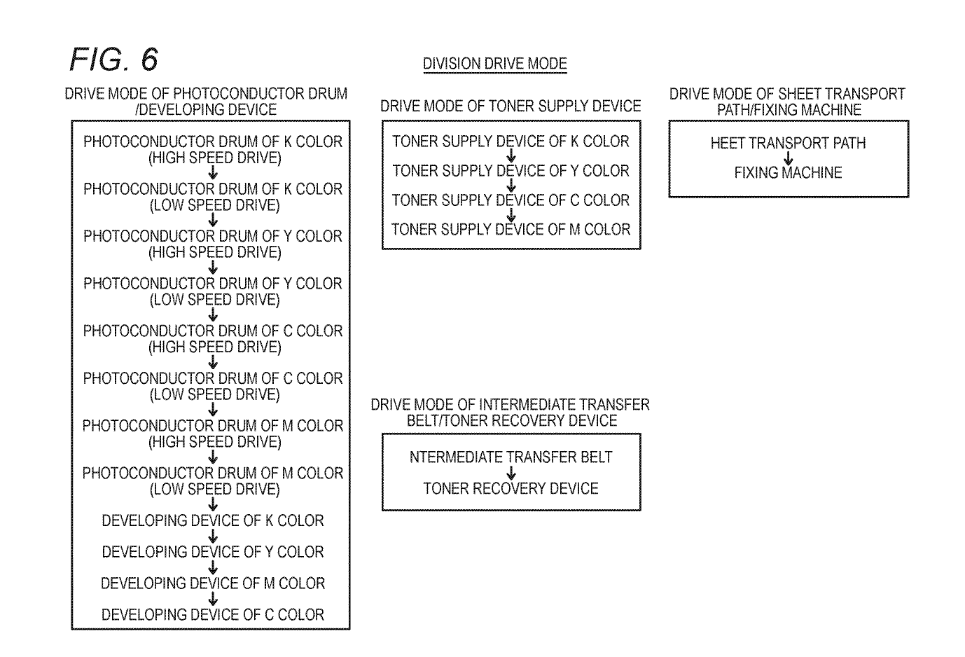

In addition, FIG. 6 illustrates an example in a case where the potential noise source components are grouped in the division drive mode.

In the example of the division drive mode illustrated in FIG. 6, for example, the drive mode of the photoconductor drum/the developing device is an operation mode for sequentially driving only the photoconductor drums and the developing devices of the respective colors. The drive mode of the toner supply device is an operation mode for sequentially driving only the toner supply devices of the respective colors.

In the division drive mode, the components in one drive mode are grouped in consideration of the positions of the respective components in the apparatus or a place where the noise is easily heard in an opening of the front door.

For example, in a case where the noise easily occurs in the sheet path and on the left side of the apparatus at the time of driving the fixing machine, the sheet path and the fixing machine are grouped and sequentially driven as one drive mode.

When the components are grouped as described above, a person who confirms the presence/absence of the noise may confirm the presence/absence of the noise in the same place without confirming the noises in various places of the apparatus.

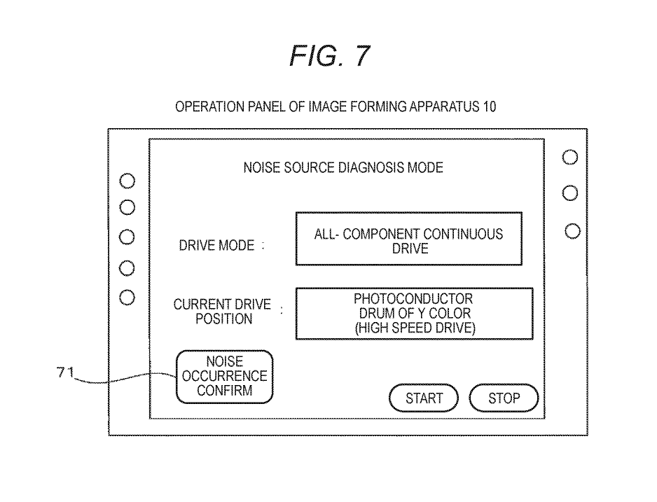

Next, an exemplary screen showing the operation panel of the image forming apparatus 10 when the noise confirming operation is performed as described above is illustrated in FIG. 7.

In the exemplary screen illustrated in FIG. 7, the all-component continuous drive mode is selected and performed as a drive mode. The component in the current drive is the “photoconductor drum of Y color” and the speed is a high speed drive.

In the exemplary screen, a noise occurrence checking button 71 is displayed on the touch panel. In a case where the user in confirming the noise confirms the noise when a certain component is being driven, the drive of the component is stopped in response to the noise occurrence checking button 71 being operated.

In other words, when the noise occurrence checking button 71 is operated, the receiving unit 32 receives the drive stop instruction from the user. When the receiving unit 32 receives the drive stop instruction, the drive controller 31 causes the driving component to be stopped.

Since the normal components are unnecessarily driven after the noise source component is specified, there may cause a secondary failure (for example, the life spans of the respective components may be shortened, or damage may be caused by driving the components). Therefore, in a case where the noise source component is specified, the component is desirably not to driven as it can be.

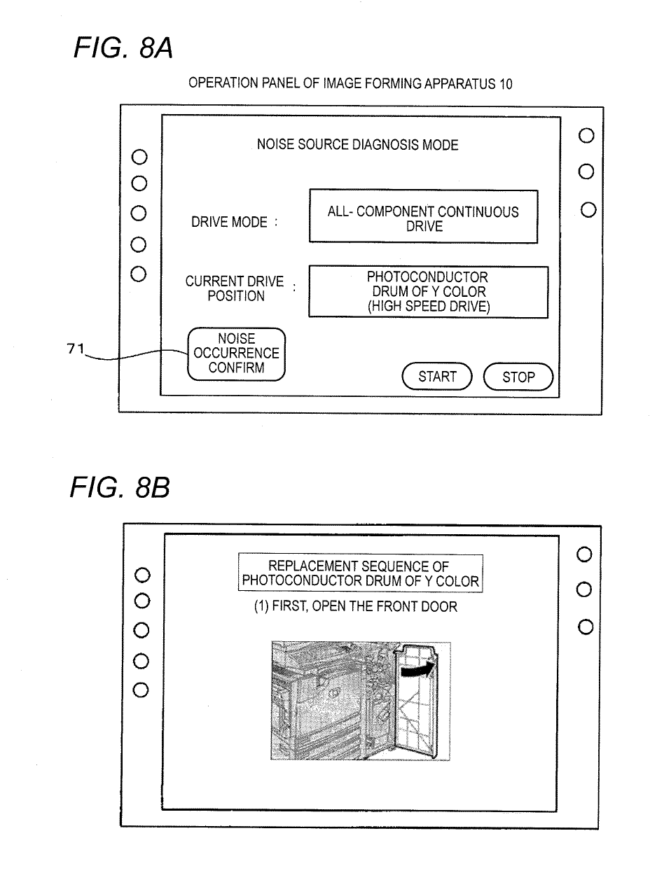

When the noise occurrence checking button 71 is operated while the photoconductor drum of Y color is being driven as illustrated in FIG. 8A, the operation information for taking noise countermeasures against the photoconductor drum of Y color which is being driven when the noise occurrence checking button 71 is operated is displayed in the operation panel as illustrated in FIG. 8B.

Herein, the operation information for taking noise countermeasures is information regarding the operation for reducing the noise. For example, as the operation information, there is information for explaining an operation method of oiling the noise-confirmed component, and a method of replacing the noise-confirmed component with a new component.

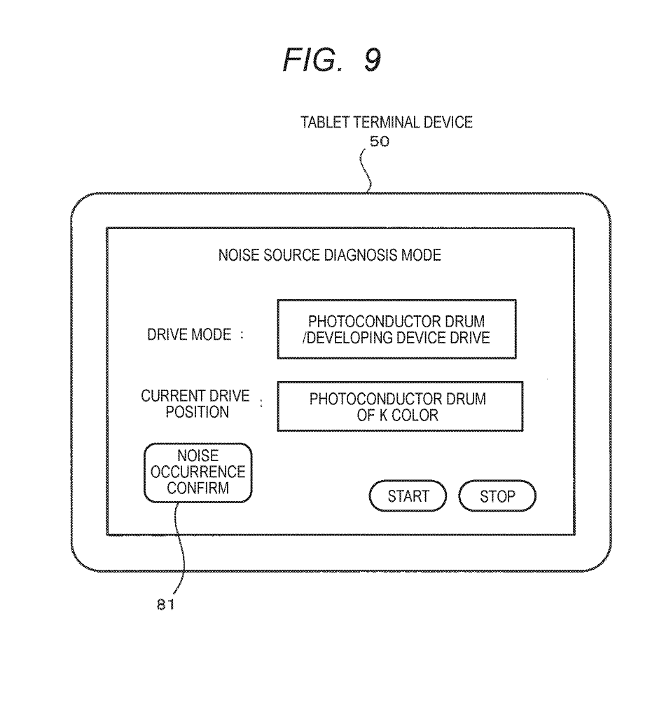

FIG. 9 illustrates an example in a case where such display content is shown by the tablet terminal device 50.

In the display example illustrated in FIG. 9, the same content as that displayed in the operation panel of the image forming apparatus 10 is displayed. Further, a noise occurrence checking button 81 to be pressed in a case where the noise occurrence is confirmed is displayed together with the current component name which is being driven.

In this way, when the component being driven is displayed in the tablet terminal device 50, the drive controller 31 transmits the information indicating the component being driven to the tablet terminal device 50 through the communication unit 34. When receiving the drive stop instruction from the tablet terminal device 50 through the communication unit 34, the drive controller 31 stops the component which is being driven, and transmits the operation information for taking noise countermeasures against the component being driven when the drive stop instruction is received to the table terminal device 50.

Then, in the tablet terminal device 50, similarly to the exemplary screen as illustrated in FIG. 8B, the operation sequence such as the replacement sequence or the oiling method with respect to the noise occurring component is displayed.

An order of driving the potential noise source components in the respective drive mode is not fixed to the initial state, but may be changed depending on various operations and information.

For example, in a case where the drive controller 31 receives the drive stop instruction of the component which is being driven, the drive controller 31 transmits the information of the component being driven when the drive stop instruction is received to the management server apparatus 40 which is an external device. The drive controller 31 may change the order of driving the potential noise source components based on an instruction from the management server apparatus 40.

In this case, when receiving the information of the noise occurring component from the image forming apparatus 10, the management server apparatus 40 generates a list of components having a high noise occurrence frequency based on the received information of the noise occurring component. The management server apparatus 40 transmits an instruction to change the order of driving the potential noise source components to the image forming apparatus 10 such that the component having a higher noise occurrence frequency is driven earlier in the order (higher order).

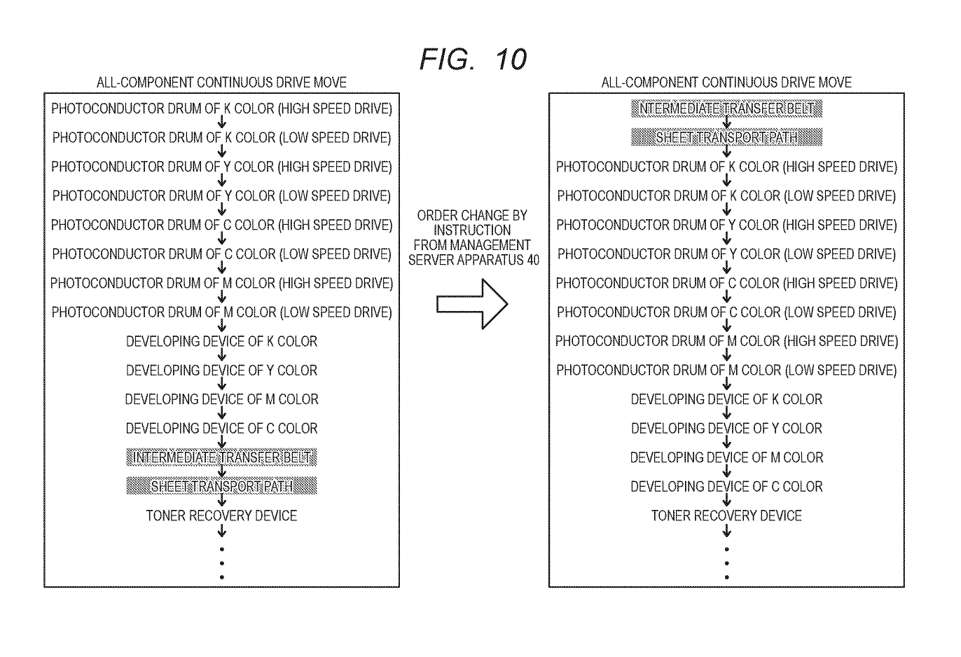

FIG. 10 illustrates an example in a case where the drive order of the respective components is changed by an instruction from the management server apparatus 40.

In the example illustrated in FIG. 10, since the noise occurrence frequency in “intermediate transfer belt” and “sheet path” is high, the management server apparatus 40 transmits an instruction to make these components driven in a higher order to the respective image forming apparatuses 10.

Therefore, in the example illustrated in FIG. 10, the drive orders of “intermediate transfer belt” and “sheet path” are changed to come earlier.

In this way, the information of the noise occurring component is collected by the management server apparatus 40 from the respective image forming apparatuses 10. The drive orders in the other image forming apparatuses 10 are changed based on the instruction from the management server apparatus 40. Therefore, even in a case where a sudden noise trouble is focused on a certain component due to a manufacturing defect of the component or a defect caused in processing/assembling/inspecting, the drive order of the component is automatically changed to come earlier.

Herein, there are various types of sounds in the noises which easily occur in a low temperature environment and sounds which easily occur in a high humidity/temperature environment. Therefore, a noise occurrence probability of the component is changed depending on an installation environment of the image forming apparatus 10. When the management server apparatus 40 creates a list of occurrence frequencies based on the information of the noise occurring component transmitted from the image forming apparatuses 10 installed in various places, the list may be created differently for each circumstance which is set in the image forming apparatus 10.

For example, a temperature sensor and a humidity sensor are provided in each image forming apparatus 10. In a case where temperature information and humidity information of the installation place are transmitted to the management server apparatus 40 together with the information of the noise occurring component, the management server apparatus 40 separately generates a list of noise occurrence frequencies in the image forming apparatus 10 installed in a high humidity/temperature area and a list of noise occurrence frequencies in the image forming apparatus 10 installed in an area other than the high humidity/temperature area.

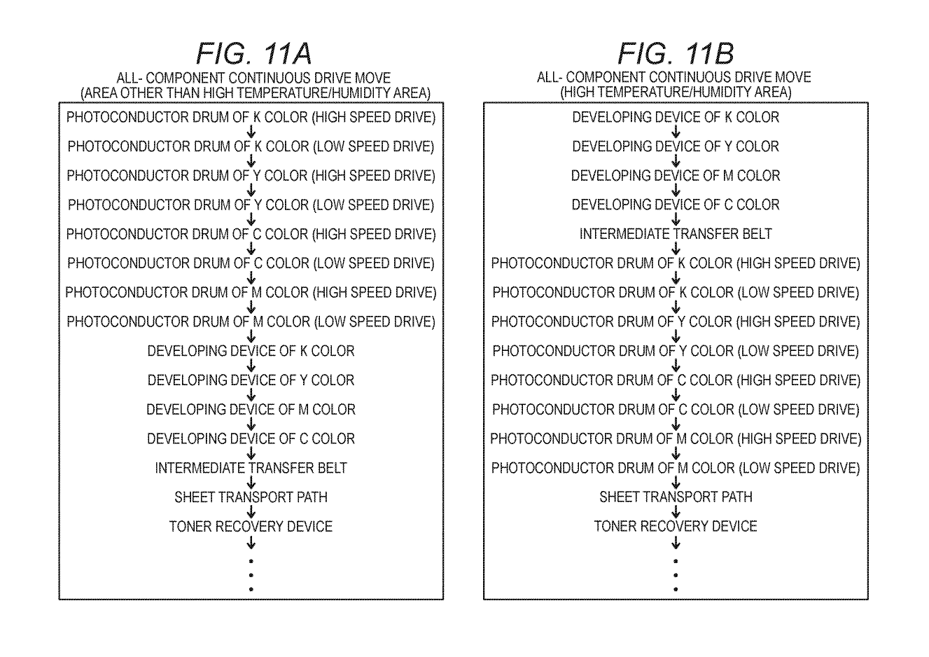

Then, the management server apparatus 40 instructs a change of the drive order for each area where the image forming apparatus 10 is installed. As illustrated in FIG. 11, the drive order of the component becomes different according to whether the installation area is a high humidity/temperature area.

In other words, in the image forming apparatus 10 installed in an area other than the high humidity/temperature area, the drive order of the respective components in the all-component continuous drive mode is set as illustrated in FIG. 11A. In the image forming apparatus 10 installed in the high humidity/temperature area, the drive order of the respective components in the all-component continuous drive mode is set as illustrated in FIG. 11B.

In the example illustrated in FIG. 11, the image forming apparatus 10 installed in the high humidity/temperature area shows a higher noise occurrence frequency of the developing device of each color. Therefore, the drive order in the image forming apparatus 10 installed in the high humidity/temperature area is changed such that the drive order of the developing device is set to come earlier.

The management server apparatus 40 which receives the information of the noise occurring component from the image forming apparatus 10 may automatically arrange a delivery of a replacement component for handling the noise occurrence, or may automatically arrange a visit of CE (customer engineer) for handling the noise.

The above description has been made about a case where the drive controller 31 changes the order of driving components based on the instruction from the management server apparatus 40 when the noise occurrence is confirmed. The drive order may be changed without receiving the instruction from the management server apparatus 40.

For example, the drive controller 31 may change the drive order of the potential noise source components based on a cumulative number of printed sheets.

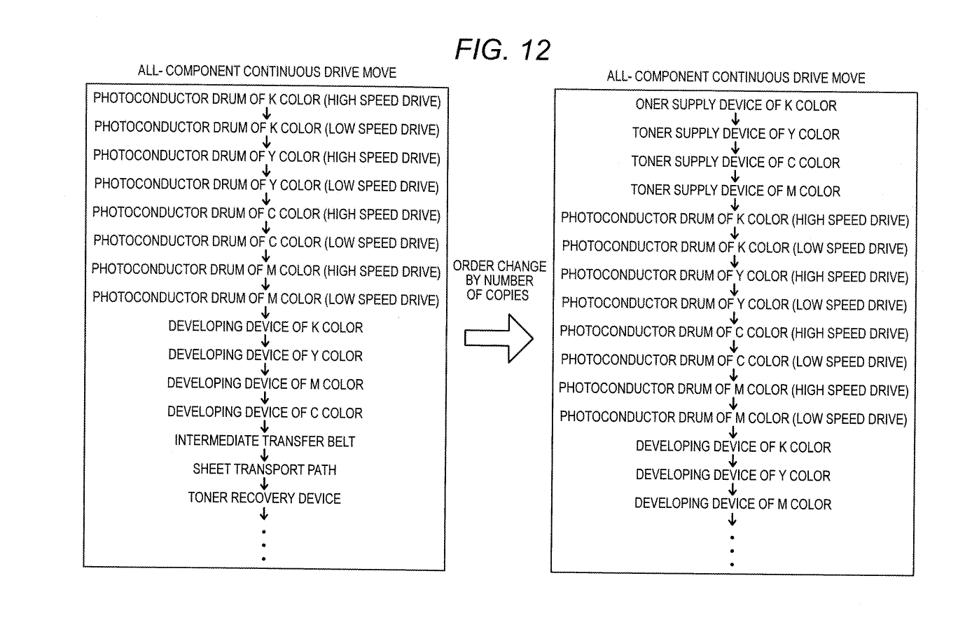

FIG. 12 illustrates an example in a case where the drive order is changed based on the cumulative number of printed sheets.

The reason why the drive order is changed according to the number of copies is that the noise occurrence frequency in a specific component is increased by abrasion when the number of copies is increased.

For example, in a case where the cumulative number of printed sheets exceeds 30,000, as illustrated in FIG. 12, the drive order in the drive mode is changed such that the drive order of the toner supply device is set to come earlier.

Therefore, the drive order of the component having a higher noise occurrence frequency is set to be higher. A possibility to unnecessarily drive a normal component is reduced. A time taken for specifying a noise source component is shortened.

In addition, in a case where the potential noise source component is replaced, the drive controller 31 may change the drive order of the potential noise source components such that the order of the replaced component becomes later (lower order).

In other words, since the noise occurrence probability of the component is remarkably lowered by replacing the component, the drive order of the component is changed to come later.

A history of the component change can be confirmed using a CRUM (Customer Replaceable Unit Memory) tag provided in a replaceable component for example. The CRUM tag is a nonvolatile memory in which identification information for specifying each component is stored. The image forming apparatus 10 reads the information in the CRUM tag to confirm whether the component is replaced.

The drive controller 31 may change a drive time during which each component is driven and an interval time (stop time) taken for a certain component from stopping the drive until starting the drive of the next component within a predetermined range based on an instruction input from the user.

The drive time of each component is set in consideration of delicateness of each component and a possibility of a secondary failure caused by the drive.

For example, when the toner supply device is driven for a long time, there may be a failure such that a concentration of an output image becomes high. In addition, when the photoconductor drum is driven for a too long time, a blade rolling-up or a streak in the output image occurs.

Therefore, an upper lime value of an allowable setting range of the drive time may be set according to a characteristic of each component. Furthermore, a lower limit value of the interval time may be set to a minimum time required for switching the operation of each component.

In addition, the potential noise source component in the above exemplary embodiment has been described using a case where the components are independently driven one by one in a predetermined order. Plural noise source components may be combined as one component group (cluster) to simultaneously be driven.

Herein, one reason for combining the plural components into one component group is that the plural components cannot be independently driven for structural difficulty. For example, in a case where the plural components are connected to one drive system, the plural components cannot be independently driven. Therefore, the plural components are necessarily simultaneously driven as one component group. In a case where one component is driven, the other component may be necessarily driven like the photoconductor drum and the intermediate transfer belt.

For such a reason, the plural components which cannot be independently driven for structural difficulty may be configured as one component group.

Even in a case where the independent drive can be made structurally, the plural components may be combined into one component group to be driven in unit of component group. For example, in a case where the number of components is large, it takes a long time for driving all the components when each component is independently driven. Therefore, the plural components are combined into component groups, and the components are sequentially driven to confirm the noise, so that a time for specifying the noise source is shortened.

The component groups of the plural components and the single components are mixed, the component groups or the components may be sequentially driven in a predetermined order.

At this time, a component having a higher possibility to be the noise source is independently driven. Plural components having a lower possibility to be the noise source are simultaneously driven as one component group. Therefore, a time reducing in specifying the noise source may be achieved.

In a case where the plural components are combined and driven as a component group as described above, the drive controller 31 controls the potential noise source component or the component group containing the plural potential noise source components among the plural components for realizing the image forming operation so as to be sequentially driven in a predetermined order (sequence) in the noise confirming operation mode for specifying the noise occurrence place.

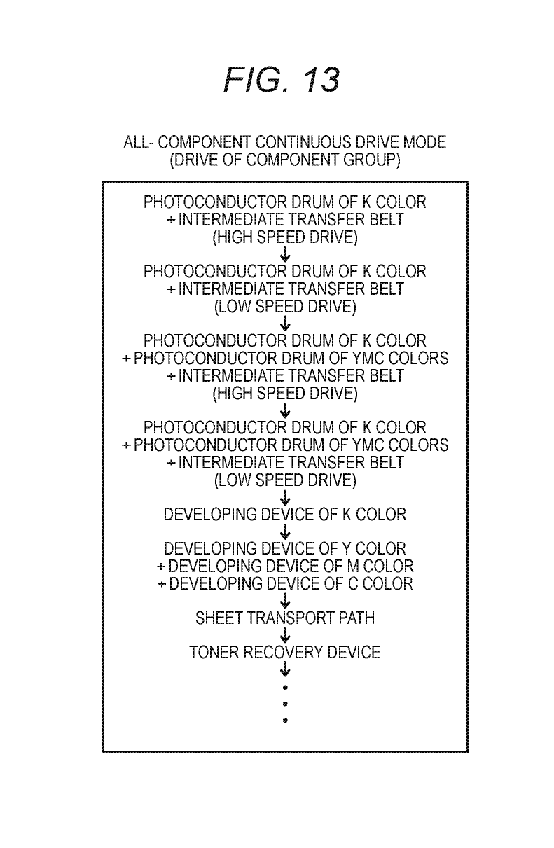

Next, an exemplary drive in a case where some of plural components are simultaneously driven as a component group with respect to the exemplary drive for each component in the all-component continuous drive mode as illustrated in FIG. 5 is illustrated in FIG. 13.

In the exemplary drive illustrated in FIG. 13, the photoconductor drum of K color and the intermediate transfer belt are simultaneously drive as one component group.

In the exemplary sequence illustrated in FIG. 13, the photoconductor drum 152K of K color and the intermediate transfer belt 16 are first simultaneously driven at a high speed. Next, the photoconductor drum 152K of K color and the intermediate transfer belt 16 are simultaneously driven at a low speed drive. Thereafter, the photoconductor drums 152Y to 152K of YMCK colors and the intermediate transfer belt 16 are simultaneously driven at a high speed. The photoconductor drums 152Y to 152K of YMCK colors and the intermediate transfer belt 16 are simultaneously driven at a low speed. In this way, the respective component groups are sequentially driven.

In FIG. 13, the developing device 156K of K color is then independently driven, and the developing devices 156Y to 156C of YMC colors are driven as one component group.

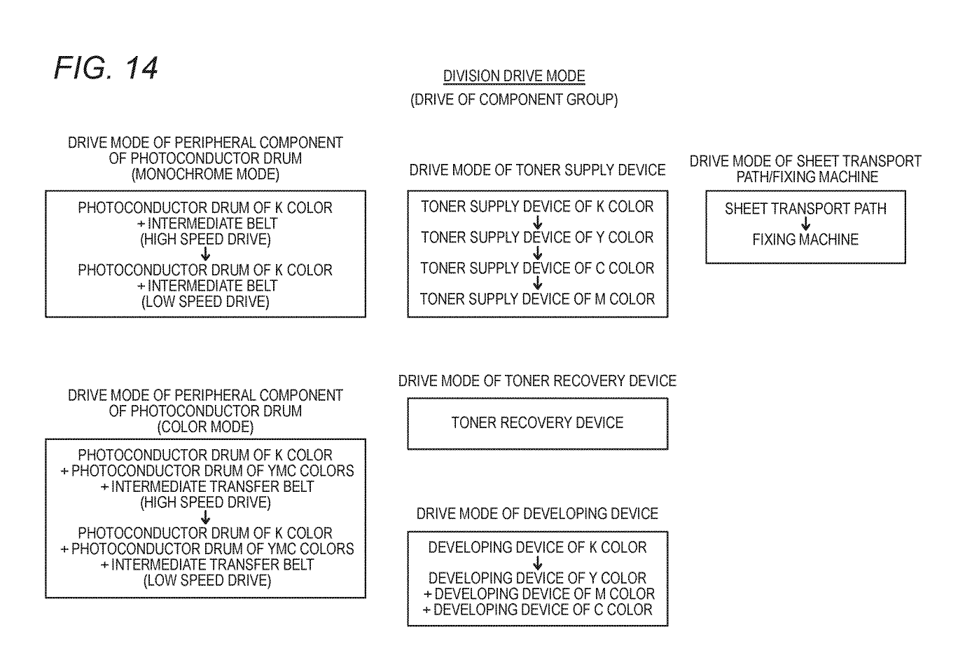

In addition, an exemplary drive in a case where some (potential noise source components) of the plural components are simultaneously driven as a component group in the division drive mode when the components are independently driven as illustrated in FIG. 6 is illustrated in FIG. 14.

In the example of the division drive mode illustrated in FIG. 14, for example, a drive mode (monochrome mode) of peripheral components of the photoconductor drum is an operation mode in which the photoconductor drum 152K of K color and the intermediate transfer belt 16 are simultaneously driven at a high speed, and then the photoconductor drum 152K of K color and the intermediate transfer belt 16 are simultaneously driven at a low speed.

In addition, a drive mode (color mode) of the peripheral components of the photoconductor drum is an operation mode in which the photoconductor drums 152Y to 152K of YMCK colors and the intermediate transfer belt 16 are simultaneously driven at a high speed, and then the photoconductor drums 152Y to 152K of YMCK colors and the intermediate transfer belt 16 are simultaneously driven at a low speed.

Even in a case where the plural potential noise source components are combined and simultaneously driven as a component group, the controls: the order of driving the respective components or the component groups is set to a descending order of the noise occurrence frequency based on history information in the past; the drive order is changed based on the cumulative number of printed sheets, the instruction input by the user, or the instruction from an external device; the drive order of the replaced component or component group is changed to come later; and the drive order of the component or the component groups is changed according to the installation circumference of the developing device (that is, the components or the component groups having a higher possibility to be the noise source are driven with higher priority or those having a lower possibility to be the noise source are driven with lower priority), can be similarly applied to a case where the components are independently driven. Herein, when some of the components in the component group are replaced, the drive order of the component group containing the components may be set to come later. On the contrary, even though some of the components in the component group are replaced, there is no change in the possibility that the other components become the noise sources. Therefore, the drive order of the component group may be not set to come later.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus, comprising:
plural components that are used to perform an image forming operation; and
at least one central processing unit (CPU) that controls a potential noise source component or a component group containing plural potential noise source components among the plural components to be sequentially driven in an operation state for specifying a noise occurrence place such that a component or a component group having a higher possibility to be a noise source is driven with higher priority or a component or a component group having a lower possibility to be the noise source with lower priority,
wherein the at least one CPU performs, in a switching manner, a control of sequentially driving all of the potential noise source component or the component group among the plural components in a descending order of possibility to be the noise source, and a control of sequentially driving some of the potential noise source component or the component group among the plural components such that a component having a higher possibility to be the noise source is driven with higher priority or a component having a lower possibility to be the noise source is driven with lower priority.

2. The image forming apparatus according to claim 1,
wherein the component group comprises plural components which are not capable of being independently driven in structure.

3. (canceled)

4. The image forming apparatus according to claim 1,
wherein an order of driving the potential noise source component or the component group by the at least one CPU is determined by a noise occurrence frequency based on past history information.

5. The image forming apparatus according to claim 1, wherein the at least one CPU is further configured to:
communicate with a mobile terminal,
wherein the at least one CPU transmits information indicating a component or a component group being driven to the mobile terminal, stops the component or the component group being driven when a drive stop instruction is received from the mobile terminal, and transmits operation information to the mobile terminal for taking a noise countermeasure against the component or the component group that is being driven at a time when the drive stop instruction is received.

6. The image forming apparatus according to claim 1, wherein the at least one CPU is further configured to:
receive a drive stop instruction,
wherein, when the at least one CPU receives the drive stop instruction, the at least one CPU stops a component or a component group being driven.

7. The image forming apparatus according to claim 6, further comprising:
a display that displays operation information for taking a noise countermeasure against the component or the component group being driven at a time when the receiving unit receives the drive stop instruction.

8. The image forming apparatus according to claim 5,
wherein, in a case where the drive stop instruction for the component or the component group being driven is received, the at least one CPU transmits information of the component or the component group being driven at the time when the drive stop instruction is received to an external device, and
the at least one CPU changes an order of driving the potential noise source component or the component group based on an instruction from the external device.

9. The image forming apparatus according to claim 1,
wherein the at least one CPU changes an order of driving the potential noise source component or the component group based on a cumulative number of printed sheets.

10. The image forming apparatus according to claim 1,
wherein, the at least one CPU changes an order of driving the potential source component or the component group with respect to a potential noise source component or a component group that is replaced such that an order of the component or the component group that is replaced is set to come later.

11. The image forming apparatus according to claim 1,
wherein the at least one CPU is capable of changing a drive time during which each component or each component group is driven and a time from stopping driving a component or component group to starting driving another component or component group within a predetermined range based on an instruction input by a user.

12. A server apparatus; comprising at least one central processing unit (CPU) configured to:
receive information regarding a noise occurring component from an image forming apparatus, the image forming apparatus controlling a potential noise source component or a component group containing plural potential noise source components among plural components for performing an image forming operation to be sequentially driven in an operation state for specifying a noise occurrence place such that a component or a component group having a higher possibility to be a noise source is driven with higher priority or a component or a component group having a lower possibility to be the noise source with lower priority; and
generate a list of components or component groups having a high noise occurrence frequency based on the information regarding the received noise occurring component, and transmit an instruction to change an order of driving the potential noise source component to the image forming apparatus such that the order of a component or a component group having a higher noise occurrence frequency is set to come earlier,
wherein the at least one CPU transmits an instruction to the image forming apparatus to perform, in a switching manner, a control of sequentially driving all of the potential noise source component or the component group among the plural components in a descending order of possibility to be the noise source, and a control of sequentially driving some of the potential noise source component or the component group among the plural components such that a component having a higher possibility to be the noise source is driven with higher priority or a component having a lower possibility to be the noise source is driven with lower priority.

13. A non-transitory computer readable medium storing a program for causing a computer to execute:
controlling an image forming apparatus to move into an operation state for specifying a noise occurrence place;
controlling a potential noise source component or a component group containing plural potential noise source components among plural components for performing an image forming operation in the image forming apparatus to be sequentially driven in the operation state for specifying the noise occurrence place such that a component or a component group having a higher possibility to be a noise source is driven with higher priority or a component or a component group having a lower possibility to be the noise source with lower priority; and
performing, in a switching manner, a control of sequentially driving all of the potential noise source component or the component group among the plural components in a descending order of possibility to be the noise source, and a control of sequentially driving some of the potential noise source component or the component group among the plural components such that a component having a higher possibility to be the noise source is driven with higher priority or a component having a lower possibility to be the noise source is driven with lower priority.
